(19) United States
(12) Patent Application Publication
(10) Pub. No.: US 2026/0023628 A1
(43) Pub. Date: Jan. 22, 2026

(54) SYSTEMS AND METHODS FOR A CALLBACK API FOR NETWORK REDIRECTION

(71) Applicant: Wolters Kluwer DXG U.S., Inc., Riverwoods, IL (US)

(72) Inventors: Mark Richard Cacciapouti, Grafton, MA (US); Keith Robert Oppenheim, Arlington, MA (US)

(21) Appl. No.: 18/776,380

(22) Filed: Jul. 18, 2024

(51) Int. Cl. G06F 9/54; G06F 16/955

(52) U.S. Cl. CPC G06F 9/547; G06F 16/9566

(57) ABSTRACT

Disclosed is a system and method for updating URL redirection. A server implementing a Short URL service receives a Short URL for redirecting a client computer system to a destination network location and obtains a first Long URL corresponding to the Short URL. Responsive to the retrieving the first Long URL, the server passes the first Long URL to a Callback API and receives an Updated Long URL from the Callback API. The Updated Long URL is generated by the Callback API responsive to receiving the first Long URL. The first Long URL corresponds to a first destination network location and the Updated Long URL corresponds to a second destination network location. The server then responds to the client computer system by causing the client computer to be redirected to the Updated Long URL returned by the Callback API.

### TECHNICAL FIELD

The present disclosure is generally related to network redirection and, in particular, updating shortened URLs (Uniform Resource Locators).

### BACKGROUND

URLs (Uniform Resource Locators) serve as the addresses to access specific web resources, ranging from articles and images to videos and documents. However, the extensive length of these URLs poses significant challenges in terms of usability, particularly in contexts where brevity and convenience are paramount, such as messaging applications and quick-response (QR) code generation. Accordingly, the concept of short URLs has gained widespread adoption. Short URLs serve as compact and abbreviated versions of their longer counterparts, providing a streamlined means of sharing and accessing web content. By condensing lengthy URLs into concise and manageable forms, Short URLs offer numerous benefits to users, including improved readability, ease of sharing across various platforms, and enhanced user experience.

Updating Long (e.g., uncondensed) URLs associated with Short URLs can be problematic, particularly where the Short URLs are already shared with end-users, either directly or embedded in a printed QR code. Short URL generation processes may be required to generate millions, or billions, of Short URLs. A typical mechanism to update Long URLs is to keep track of all Short URLs for a Long URL and then update the Long URL associated with each Short URL. However, the ability to make the updates “on-the-fly” is limited by the amount of updates that must be performed and the storage space available for maintaining Long URL associations (e.g., the requirement to store potentially large numbers of Short URLs). Additionally, long URLs may become invalid or inappropriate based on activities unrelated to the short URL and long URL associations. Moreover, reversing a change or comparing changes over time becomes untenable as current systems do not typically maintain a history of changes for each Long URL as such a large scale system would not come without significant cost to system resources.

### SUMMARY

A system and method for efficiently updating shortened URLs using a callback application programming interface (API) is disclosed. According to various aspects, a method includes receiving, by a first server, a Short URL for redirecting a client computer to a destination network location associated the Short URL; obtaining, by the first server from a first database, based on the received Short URL, a first Long URL and an indication of a Callback API for confirming the first Long URL; and responsive to obtaining the indication of the Callback API: passing the first Long URL to the Callback API; and causing the client computer to be redirected to an Updated Long URL returned by the Callback API based on passing the first Long URL to the Callback API. In this regard, the method may include receiving the Updated Long URL from the Callback API responsive to the passing; and sending, to the client computer, a redirect response containing the Updated Long URL, wherein the redirect response is configured to cause the client computer to automatically navigate to the destination network location using the Updated Long URL without user intervention. Other aspects include corresponding systems, apparatus, and computer program products for implementation of the corresponding method and its features.

Accordingly, to update a single Long URL, all Short URLs associated with the Long URL need not be known or updated. The Long URL is located and updated, in real-time, via the Callback API. The Callback API may implement one or more rules to determine when a Long URL is to be updated and may provide an update mechanism for causing an update to a Long URL. The updates to the Long URL can be made at run-time without impacting existing Short URL services in a primary database. Furthermore, by using a Callback API, updates can be triggered based on one or more factors, such as a Short URL generation time, a Short URL access time, a history of changes to elements related to the Long URL, and/or other factors, which can be analyzed to determine whether a Long URL should be updated.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

For a better understanding of the various described implementations, reference should be made to the Description below, in conjunction with the following drawings. Like reference numerals refer to corresponding parts throughout the figures and description.

FIG. 1 depicts a block diagram of an example system for implementing a Callback API service for network redirection, in accordance with some embodiments;

FIG. 2 depicts a sequence diagram of an example process for implementing a Callback API service for network redirection, in accordance with some embodiments;

FIG. 3 depicts an example process flow diagram for implementing a Callback API service for network redirection, in accordance with some embodiments; and

FIG. 4 is a conceptual diagram illustrating an example electronic system for implementing a Callback API service for network redirection, according to aspects of the subject technology.

### DESCRIPTION

Reference will now be made to implementations, examples of which are illustrated in the accompanying drawings. In the following description, numerous specific details are set forth in order to provide an understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

Disclosed herein is a system and method for efficiently updating shortened URLs using a callback API. The subject technology pairs the shortening of a URL with a dynamic “on-the-fly” mechanism to determine where to redirect the shortened URL based on the original URL that was shortened. In some implementations, a new URL is determined for the shortened URL based on contextual information such as a timestamp indicating when the original URL was shortened, a timestamp indicating when the shortened URL is accessed, and/or an indication of one or more update events that have occurred since generation of the shortened URL.

According to various implementations, a server implements a Short URL API service that converts Short URLs to Long URLs to redirect client computer systems. When a Short URL is subsequently received from a respective client computer system, the server obtains a first Long URL corresponding to the Short URL. When looking up the Long URL, the server determines whether the Long URL remains valid. In some embodiments, before responding to the client computer system, the server passes the Long URL to a Callback API and may receive an Updated Long URL from the Callback API. The server then responds to the client computer system by causing the client computer to be redirected to the Updated Long URL returned by the Callback API instead of the Long URL that was originally created.

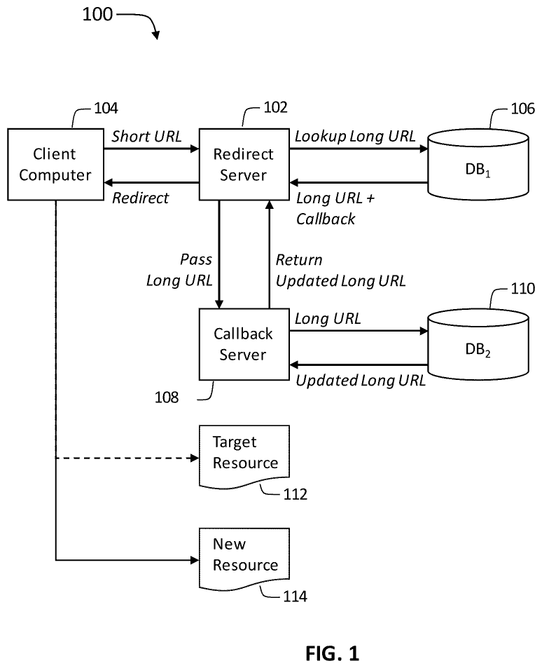

FIG. 1 depicts a block diagram of an example system 100 for implementing a Callback API service for network redirection, according to aspects of the subject technology. Short URLs are compact, simplified versions of a Long URL. They are typically created by a URL shortening services that takes a Long URL and generates a unique shorter alias for it. The URL shortening service stores a mapping between the Short URL and the original Long URL in a database or some other form of data storage. The Short URL is then returned to the user, who may then share the Short URL with other users who wish to access the resource associated with the corresponding Long URL.

Each Short URL generally includes (e.g., embedded therein) the address of a Short URL redirection service—typically on the same server system 102 as the URL shortening service—together with a unique identifier for the Short URL redirection service to lookup the longer URL. In contemporary enterprise computing, when a user clicks on (or otherwise inputs) the Short URL, the Short URL redirection service receives a request (e.g., an HTTP request) from the client computer system 104 for the original, Long URL, and looks up the corresponding Long URL in its database 106. It may then redirect the client computer system 104 (e.g., the user's browser) to the original Long URL (e.g., by way of a server-side redirect).

The disclosed system adds a Callback API service for management of updated and/or changed Long URLs in real-time. In the depicted example, the Callback API service is implemented in a separate server 108; however, the Callback API service may reside on the same client computer 104 as the URL redirection service. The disclosed Callback API service is configured identify one or more triggers requiring update of a Long URL. The Callback API may retrieve and/or generate an Updated Long URLs when necessary. In some implementations, the URL redirection server 102, the database 106, and/or the Callback API reside on the same server or server cluster.

When a Short URL is activated (e.g., clicked, scanned, hyperlinked, etc.), the client computer system 104 is navigated (e.g., within the user's browser) to the URL redirection server 102 designated by the embedded network address within the Short URL. According to various implementations described herein, the URL redirection server includes a Short URL API service which receives the Short URL and performs a lookup of a corresponding Long URL in its database 106. The Short URL may have been previously generated and associated with the Long URL by a conventional mechanism for generation of Short URLs. Under conventional methods, the Long URL is used to redirect the client computer system 104 to a target resource 112.

The subject technology provides, in the database 106 of the Short URL API service, the ability to associate an indication of a callback with the Long URL. As will be described further, the callback provides a mechanism by which the Short URL API service can perform a real-time determination of whether the Long URL has been updated, changed, invalidated, etc., by identifying the indication of the callback when the Long URL lookup is performed. When a callback is identified, the Short URL API service passes the Long URL (designating a target resource such as a website) to the Callback API service before responding to the client computer system 104.

The Callback API receives the Long URL corresponding to the target resource 112 and implements one or more operations to update the Long URL, if necessary. Unlike the Short URL API service (or other URL redirection service), the Callback API service determines whether the Long URL is valid based on one or more parameters and may perform a lookup by using the Long URL received from the URL redirection service. As will be described further, the determination by the Callback API and/or generation of the Updated Long URL may be based on one or more parameters such as a timestamp, client identifier, event flag, etc. The Callback API service obtains and/or generates an Updated Long URL that designates a new resource 114 and returns the Updated Long URL to the Short URL API service, all before the Short URL API service responds to the initial request from the client computer system 104. The Short URL API service uses the Updated Long URL instead of the Long URL it retrieved from the database 106 and responds to the client computer system by causing the client computer to be redirected to the new resource 115 by way of a redirect based on the Updated Long URL.

The Updated Long URL may be an entirely different URL or may be used to add or change parameters in the existing (first) Long URL. In some implementations, the Updated Long URL may accommodate different formats for different entities, or to change a language of the URL (e.g., from English to Spanish) or portions thereof based on different countries or demographic groups identified in the database as being associated with the Short URL.

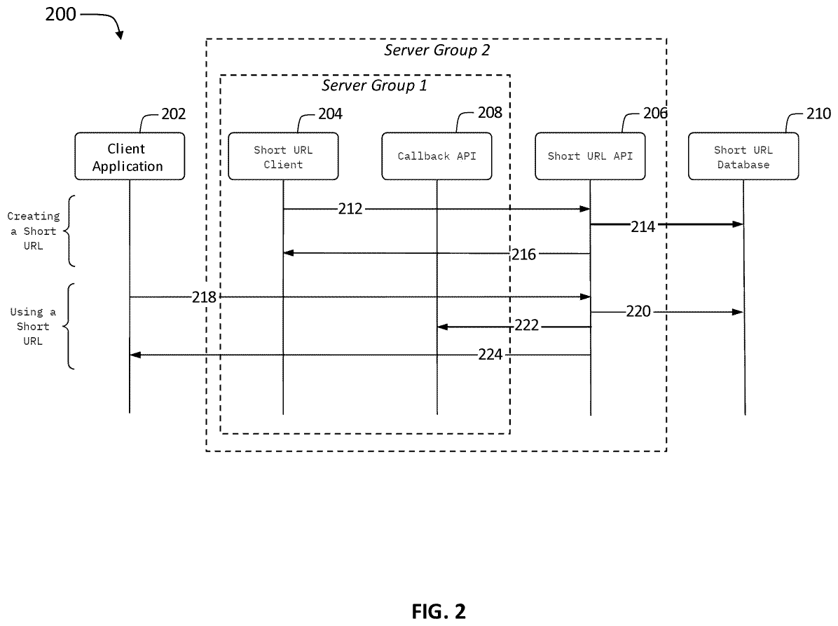

FIG. 2 depicts a sequence diagram of an example process for implementing a Callback API service for network redirection, according to aspects of the subject technology. The system 200 of FIG. 2 depicts an interaction between a Client Application 202 (e.g., on client computer system 104) and a Short URL Client 204 and a Short URL API 206, and further between the Short URL Client 204 and Short URL API 206 and a Callback API 208 and one or more databases 210.

In some implementations, the Short URL Client 204 and Callback API 208 reside together on a single server or server cluster as a single service or service group (e.g., “Server Group 1” in the depicted example). In this regard, these services may be on a separate server or otherwise separated virtually from the Short URL API 206. In some implementations, all three services may be part of the same server group (e.g., “Server Group 2” in the depicted example). The depicted database 210 is representative of the first database 106 and/or one or more additional databases, which may each be hosted on the same or separate server(s).

According to various implementations, the Short URL Client 204 includes or is implemented as a service (e.g., a webpage or web-based application) which is exposed to users and user applications (e.g., Client Application 202) for the purpose of generating Short URLs. A user may, for example, cut and past a Long URL of a target resource 112 for which the user wants to create a Short URL for, and the Short URL Client 204 handles communication with the Short URL API 206 to generate the requested Short URL. In some implementations, the Short URL Client 204 may be representative of a backend service exposed to one or more Client Applications 202 via an API or other interface. A user may call the Short URL Client 204 via the user's web browser or web-based application on a client computer system 104 and receive a Short URL (e.g., textual URL, QR code, etc.) responsive to a request for a Short URL.

The depicted example includes examples of creating a Short URL as well as using a Short URL, according to aspects of the subject technology. With regard to creation of a Short URL, the Short URL Client 204 initiates creation of the Short URL by calling (212) the Short URL API 206, passing a Long URL to be shortened. The Short URL API 206 generates a Short URL for the Long URL according to predetermined rules, and stores (214) the Long URL in the Short URL Database 210 (e.g., in database 106 of FIG. 1) in association with the newly generated Short URL. In some implementations, during the generation process, a unique identifier is generated and/or identified, associated with the Long URL in the database, and embedded in the newly created Short URL. In some embodiments, if a Short URL has previously been generated for a corresponding Long URL, a request to generate a Short URL will return the preexisting Short URL. A Long URL lookup may be implemented by the Short URL API 206 prior to generating a Short URL to identify a preexisting Short URL for a corresponding Long URL.

According to various implementations, the Short URL API 206 also associates the Short URL and corresponding Long URL (and/or unique identifier) with a URL or other identifier for the Callback API 208. The Short URL API 206 then returns (216) the Short URL (including, e.g., the unique identifier embedded therein) to the Short URL Client. In some implementations, the Short URL, the Long URL, and/or the unique identifier, may be further associated in the Short URL Database 210 with a client identifier and/or a timestamp indicating a time when the Short URL was created in the database.

When the Short URL is later used, it causes a Client Application 202, typically a user's browser, to navigate to the Short URL API 206 (218) (based on, e.g., the address of the Short URL API being embedded in the Short URL). The Short URL API 206 looks up the Short URL in the Short URL Database 210 (220) and obtains the Long URL associated with the Short URL in the database. For example, the Short URL API 206 may extract and/or generate the unique identifier from the Short URL and index the Short URL Database 210 using the unique identifier to obtain the original Long URL and indication of the callback. In some embodiments, the unique identifier includes an encoding, e.g., base64 encoding, of the Short URL, allowing retrieval of a Long URL without the need for a secondary index.

In some embodiments, one or more update events may require an updated Long URL to be associated with the Short URL. For example, in some instances, the unique identifier associated with the Short URL and/or the Long URL may be updated and/or reused such that information contained at the Long URL is no longer valid and/or associated with the unique identifier. In such embodiments, it may be necessary to update the Long URL associated with the Short URL to prevent incorrect redirections when the Short URL is utilized. As another example, in some embodiments, a Long URL may include one or more parameters that are time and/or context sensitive, requiring update of the Long URL to revise and/or complete the corresponding parameters.

In some embodiments, the Short URL API 206 is configured to pass the Short URL, Long URL, and/or other information to a Callback API 208 that is configured to determine whether the Long URL associated with the Short URL requires updating based on one or more events. For example, the Short URL API 206 may call (222) the Callback API 208, passing the Short URL, Long URL, and/or other data retrieved from the Short URL Database 210. In some implementations, a timestamp is also stored in the Short URL Database 210 indicating, for example, when the Long URL was shortened; and this timestamp may also be retrieved and sent by the Short URL API 206 to the Callback API 208 with the Long URL. The Callback API 208 uses the Long URL (and/or other information passed to it) to determine whether an updated Long URL is required for the corresponding short URL. The Callback API may implement one or more predetermined operations (e.g., rules) to generate an Updated Long URL and/or may perform a lookup for an Updated Long URL in an Updated Long URL database. For example, as will be described further, the timestamp may be used by the Callback API 208 to determine when an Updated Long URL is required. The Callback API 208 then returns the Updated Long URL to the Short URL API 206 for use in redirecting the Client Application 202. Once obtained, the Updated Long URL is returned (224) to the Client Application 202, for example by way of the Short URL API 206 issuing a server side redirect, and the Client Application 202 follows the redirect to the destination.

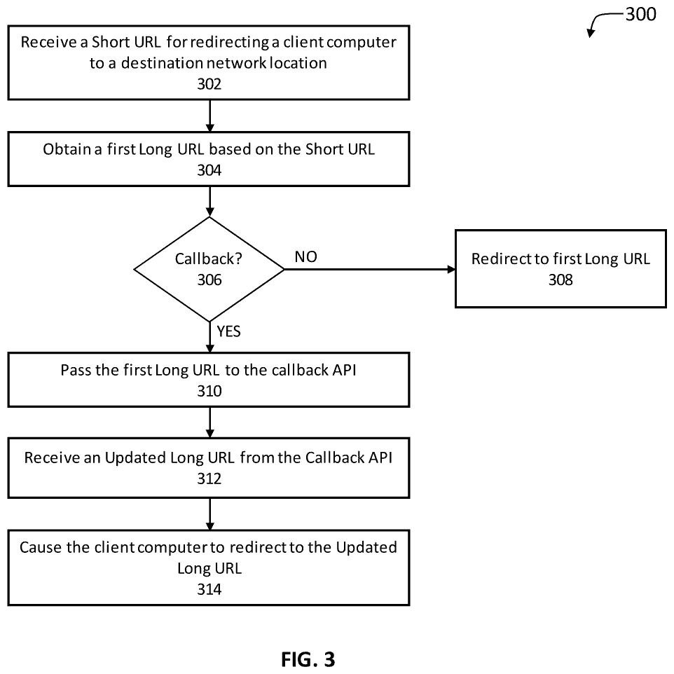

FIG. 3 depicts an example process flow diagram for implementing a Callback API service for network redirection, according to aspects of the subject technology. For explanatory purposes, the various blocks of example process 300 are described herein with reference to FIGS. 1 and 2, and the components and/or processes described herein. One or more of the blocks of process 300 may be implemented, for example, by one or more servers associated with Client Application 202, Short URL Client 204, Short URL API 206, and/or Callback API 208, or any combination thereof. In some implementations, one or more of the blocks may be implemented apart from other blocks, and by one or more different processors (including virtual processors) or devices. Further for explanatory purposes, the blocks of example process 300 are described as occurring in serial, or linearly. However, multiple blocks of example process 300 may occur in parallel. In addition, the blocks of example process 300 need not be performed in the order shown and/or one or more of the blocks of example process 300 need not be performed.

In the depicted example, a Short URL API 206, operating on a server 102, receives a previously created Short URL for redirecting (302) a Client Application 202 of a client computer 104 to a destination network location. The Short URL may be received from the Client Application 202, which may be a client application, such as a browser or a web based application (e.g., a mobile app on a mobile device). For the purpose of the depicted example, server 102 and the Short URL API 206 operating on the server 102 may be referenced interchangeably.

The server 102 (e.g., Short URL API 206) obtains a first Long URL based on the received Short URL (304). For example, the server 102 may query a Short URL Database 210 (e.g., database 106) based on the received Short URL. In some implementations, the server 102 may first extract and/or generate a unique identifier from the Short URL and then query the database based on the unique identifier. In either case, the database returns a first Long URL that was previously associated with the Short URL in the database (e.g., by way of the Short URL creation process described with regard to FIG. 2).

In some embodiments, the server 102 then determines (306) whether the received first Long URL and/or the Short URL is associated with a callback. For example, the server 102 may determine whether a flag is set in a database record associated with the first Long URL. In some implementations, an address of a Callback API service is part of the record (e.g., representing that the flag being set). Other information may be additionally or alternatively included in the record, such as a timestamp indicating a time at which the Short URL was created in the database or a client identifier of a user, entity, or system that created the Short URL. In some embodiments, the determination step (306) is omitted and all retrieved Long URL-Short URL pairs are provided to the Callback API 208 as discussed below. In some embodiments, the client identifier is associated with an account that created the Short URL, such as an account associated with the Short URL Client 204. In this regard, the Short URL Client 204 may choose to associate the client identifier with a flag indicating whether all the Long URLs created by the Short URL Client 204 are associated with a callback. While resolving the Long URL, the Short URL API 206 retrieves the flag based on the client identifier and uses the flag to determine if Long URL is associated with a callback.

In some embodiments, when no callback is identified, the server 102 causes the Client Application 202 to be redirected to the first Long URL (308). The redirection may be caused by way of the server 102 issuing an HTTP redirect response (e.g., code 302 moved) back to the Client Application 202.

If a callback is identified for the Short URL (and/or the unique identifier or first Long URL) then the first Long URL, Short URL, and/or other retrieved information is passed (310) to the Callback API 208. For example, the server 102 may query the Callback API 208 based on the first Long URL (or its associated unique identifier) as a query parameter. In some implementations, the client identifier and/or the timestamp corresponding to when the Short URL was created is also retrieved and also sent to the Callback API together with the Long URL.

According to various implementations, the address of the Callback API 208 is predetermined. In some implementations, though, the address of the Callback API 208 may be different for each client entity. For example, when a first Long URL is created and stored in the Short URL Database 210, the client entity creating the Long URL (e.g., user account associated with the Short URL Client 204) may choose to associate a client identifier with the Short or Long URL. In some implementations, the Short URL API 206 will associate a client identifier associated with a user account that created the Short URL; for example, an account associated with the Short URL Client 204. In this regard, the Short URL Client 204 may choose to associate the client identifier with a network address of a Callback API 208 specific to the client entity. While resolving the Long URL, the Short URL API 206 retrieves the address of the Callback API 208 based on the client identifier, and then uses the address to call the Callback API 208 and obtain an Updated Long URLs for Short URLs created by or for the client entity. In such implementations, each respective Callback API may be a separate service hosted in the same server group, or may be hosted on a server particular to the client entity (e.g., on the client's own server). Accordingly, different Callback APIs may be used for different language translations of the Updated Long URL (or parameters to be updated therein).

The depicted method proceeds by the server 102 receiving (312) an Updated Long URL from the Callback API 208. The Callback API 208 receives the query information (e.g., Long URL, Short URL, timestamp, client identifier, other context information, etc.) and determines whether an Updated Long URL is required. In this regard, the Callback API 208 generates, based on the query, an Updated Long URL that corresponds to the Short URL. For example, the Callback API 208 may be configured to apply one or more rules for generating an Updated Long URL for a corresponding first Long URL and/or a Short URL. The Callback API may use (or the database may return) only the Updated Long URL for requests received after some time period from the timestamp associated with the Short URL. regarding some embodiments, a history of updates may be maintained by the Callback API 208. In some implementations, the Callback API may be configured to dynamically generate an Updated Long URL each time a Long URL-Short URL pair is received by the Callback API. For example, the Callback API may read the current time and return a Long URL appropriate for the current time and/or other current parameters.

According to various implementations, an Updated Long URL may be generated for a Short URL at any time, without impacting the overall functionality. For example, during a first period of runtime, an Updated Long URL may not be required and the Short URL API 206 will continue to return the first Long URL. During a second period of runtime, e.g., after an update event, such as an external event changing an association of data originally referenced by the Short URL, one or more Updated Long URLs may be generated for requests based on the Short URL. Updated Long URLs may include any URL. For example, the Updated Long URL may be an entirely different URL than the first Long URL, thus resolving in an entirely different network address. Additionally or in the alternative, an Updated Long URL may merely change or add a parameter to the first Long URL, or change a format of one or more parameters of the first Long URL without changing the URL itself. In some implementations, the Callback API 208 may be used to add or change security parameters or to switch security protocols (e.g., HTTP to HTTPS).

Once the Updated Long URL is generated, the server 102 causes the Client Application 202 to be redirected (314) to an address of the Updated Long URL. In some implementations, the server issues an HTTP redirect response (e.g., code 302 moved) back to the client computer based on the Updated Long URL. The redirect response contains the Updated Long URL, and the Client Application 202 is caused to automatically navigate to a network location associated with the Updated Long URL without user intervention.

In some implementations, the client request 218 for the Long URL and resulting redirect response 224 may be handled by client-server process calls such as JavaScript API calls. In this regard, the Client Application 202 may initiate a process call to the Short URL API, which obtains the Updated Long URL (or Long URL when an updated URL is otherwise not available) and passes the URL back to the Client Application 202 as a result parameter.

The subject technology thus solves the problem of updating Long URLs associated with Short URLs, where the Short URLs are already shared with end-users—either directly or when embedded in a printed QR code—and there is a need to update the ultimate destination (the Redirect Long URL). The uses for this capability range from adapting to changing requirements by making minor alterations to the original Long URL, for example by adding a query parameter, to redirecting to an entirely different Long URL, for example in a case where the information displayed in the Long URL page is obsolete. This is critical when the Short URL is used to provide access to information that could be damaging if incorrect, such as information about a drug.

Accordingly, the subject technology includes providing a hook—the previously described Callback API—to solve the problem of updating Short URLs, thus allowing a client to dynamically compute the Redirect Long URL “on-the-fly” in code that it controls when the Short URL is used. Without this solution, a client would need to call a Short URL service to update Long URLs associated with Short URLs in the Short URL Database. When done at scale, such conventional solutions would be a time-consuming and error-prone process. In addition, if a client needs to update Long URLs associated with Short URLs, the conventional solution would require its own database to store Short URL and Long URL pairs to determine which Long URLs need updating. The subject technology relieves a client of the burden of storing all Short URLs it created, and allows the client to create code that it owns to update the destination of Short URLs that need updating.

An example scenario in which the subject technology may be used involves the creation of Short URLs for drug codes that may be reused over time. For example, an Short URL API may be used to create Short URLs that direct users to medication leaflets regarding drugs they are taking, along with additional information regarding the drug and consumer education related to the user's medical condition. The Short URL API may also enable customers to create a QR code with an embedded Short URL, which is printed on a prescription label. The destination of the Short URLs may be a web application hosted on a central server 102.

The drug that is the subject of the Short URL may be identified via a National Drug Code (NDC) issued by the US FDA, and the NDC may be embedded in the Long URL that was shortened, may be embedded in the Short URL that is generated, and/or may be a unique identifier associated with the Long URL and/or the Short URL. An NDC can be retired and/or disused for a first drug and reused by a drug manufacturer for a second, different drug. The subject technology can be used to redirect users that are using a Short URL (or a QR code) that was issued before the NDC was reused to a webpage or other resource 114 that indicates information is not available for the drug, effectively rendering the Short URL or QR code obsolete. This provides a critical safety measure, ensuring a healthcare practitioner is not providing information on the wrong drug to a user.

According to various examples, the Short URL Client 204, Callback API 208, Short URL API 206, and Short URL Database 210 may all be hosted by the same central server system. Customers may call an API exposed by the Short URL Client to create Short URLs for an NDC, and the end users will be those of the customer.

A Long URL may include more than a single parameter, such as a NDC. It can contain many parameters, across many customers. This results in a potentially high volume of Short URLs in a Short URL Database that correspond to even a single NDC. Thus, while the same outcome could be achieved by updating all required Short URLs in the Short URL Database, such a solution would require a small project every time an NDC has to be made obsolete, and could entail updating many thousands of database records in a database that is under constant use. The subject technology provides a solution with a small amount of code that can be created and tested once, along with a simple data-driven process that stores obsolete NDCs in a database. This reduces the process of obsoleting an NDC to a simple database update. Accordingly, the subject technology facilitates safety and quality of content used by customers, and enables users to make changes in a highly efficient manner.

Many of the above-described example steps of process 300, and related features and applications, may also be implemented as software processes that are specified as a set of instructions recorded on a computer readable storage medium (also referred to as computer readable medium), and may be executed automatically (e.g., without user intervention). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

The term “software” is meant to include, where appropriate, firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

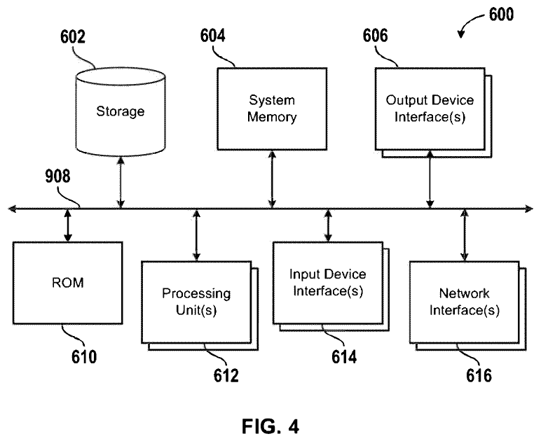

FIG. 4 is a conceptual diagram illustrating an example electronic system for implementing a Callback API service for network redirection, according to aspects of the subject technology. Electronic system 400 may be a specifically configured computing device for execution of software associated with one or more portions or steps of process 300, or components and processes provided by FIGS. 1 through 3, including but not limited to a client computer system 104, server system 102 or server system 108. Electronic system 400 may be or include a server, a personal computer or a mobile device such as a smartphone, tablet computer, laptop, PDA, an augmented reality device, a wearable such as a watch or band or glasses, or combination thereof, or other touch screen or television with one or more processors embedded therein or coupled thereto, or any other sort of computer-related electronic device having network connectivity.

Electronic system 400 may include various types of computer readable media and interfaces for various other types of computer readable media. In the depicted example, electronic system 400 includes a bus 408, processing unit(s) 412, a system memory 404, a read-only memory (ROM) 410, a permanent storage device 402, an input device interface 414, an output device interface 406, and one or more network interfaces 416. In some implementations, electronic system 400 may include or be integrated with other computing devices or circuitry for operation of the various components and processes previously described.

Bus 408 collectively represents all system, peripheral, and chipset buses that communicatively connect the numerous internal devices of electronic system 400. For instance, bus 408 communicatively connects processing unit(s) 412 with ROM 410, system memory 404, and permanent storage device 402.

From these various memory units, processing unit(s) 412 retrieves instructions to execute and data to process, in order to execute the processes of the subject disclosure. The processing unit(s) can be a single processor or a multi-core processor in different implementations.

ROM 410 stores static data and instructions that are needed by processing unit(s) 412 and other modules of the electronic system. Permanent storage device 402, on the other hand, is a read-and-write memory device. This device is a non-volatile memory unit that stores instructions and data even when electronic system 400 is off. Some implementations of the subject disclosure use a mass-storage device (such as a magnetic or optical disk and its corresponding disk drive) as permanent storage device 402.

Other implementations use a removable storage device (such as a floppy disk, flash drive, and its corresponding disk drive) as permanent storage device 402. Like permanent storage device 402, system memory 404 is a read-and-write memory device. However, unlike storage device 402, system memory 404 is a volatile read-and-write memory, such as a random access memory. System memory 404 stores some of the instructions and data that the processor needs at runtime. In some implementations, the processes of the subject disclosure are stored in system memory 404, permanent storage device 402, and/or ROM 410. From these various memory units, processing unit(s) 412 retrieves instructions to execute and data to process in order to execute the processes of some implementations.

Bus 408 also connects to input and output device interfaces 414 and 406. Input device interface 414 enables the user to communicate information and select commands to the electronic system. Input devices used with input device interface 414 include, e.g., alphanumeric keyboards and pointing devices (also called “cursor control devices”). Output device interfaces 406 enables, e.g., the display of images generated by the electronic system 400. Output devices used with output device interface 406 include, e.g., printers and display devices, such as cathode ray tubes (CRT) or liquid crystal displays (LCD). Some implementations include devices such as a touchscreen that functions as both input and output devices.

Also, as shown in FIG. 4, bus 408 also couples electronic system 400 to a network (not shown) through network interfaces 416. Network interfaces 416 may include, e.g., a wireless access point (e.g., Bluetooth or WiFi) or radio circuitry for connecting to a wireless access point. Network interfaces 416 may also include hardware (e.g., Ethernet hardware) for connecting the computer to a part of a network of computers such as a local area network (“LAN”), a wide area network (“WAN”), wireless LAN, or an Intranet, or a network of networks, such as the Internet. Any or all components of electronic system 400 can be used in conjunction with the subject disclosure.

Each network connections disclosed herein may be a wired or wireless connection, such as by Ethernet, WiFi, BLUETOOTH, an integrated services digital network (ISDN) connection, a digital subscriber line (DSL) modem, or a cable modem. Direct or indirect network connection may be used, including, but not limited to a telephone modem, an MIB system, an RS232 interface, an auxiliary interface, an optical link, an infrared link, a radio frequency link, a microwave link, a personal area network connection, a local area network connection, a cellular link, or a WLANS connection or other wireless connection.

Enterprise devices incorporating aspects of the subject technology may be equipped with a network interface module (NIM), allowing each device to participate as a node in a network. While for purposes of clarity the subject technology will be described as operating in an Ethernet network environment using the Internet Protocol (IP), it is understood that concepts of the subject technology are equally applicable in other network environments, and such environments are intended to be within the scope of the subject technology.

Data to and from the various data sources can be converted into network-compatible data with existing technology, and movement of the information between the appliances and the network can be accomplished by a variety of means. For example, the appliances and network may communicate via automated interaction, manual interaction, or a combination of both automated and manual interaction. Automated interaction may be continuous or intermittent and may occur through direct network connection, or through RS232 links, MIB systems, RF links such as BLUETOOTH, IR links, PANS, LANS, WLANS, digital cable systems, telephone modems or other wired or wireless communication means. The communication means in various aspects may be bidirectional with access to data from as many points of the distributed data sources as possible. Decision-making can occur at a variety of places within the network.

These functions described above can be implemented in computer software, firmware, or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (also referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to specifically configured electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; e.g., feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; e.g., by sending web pages to a web browser on a user's client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and may interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. The described functionality may be implemented in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

### Illustration of Subject Technology as Clauses:

Various examples of aspects of the disclosure are described as numbered clauses (1, 2, 3, etc.) for convenience. These are provided as examples, and do not limit the subject technology. Identifications of the figures and reference numbers are provided below merely as examples and for illustrative purposes, and the clauses are not limited by those identification.

Clause 1. A computer-implemented method, comprising: receiving, by a first server, a Short URL for redirecting a client computer to a destination network location associated the Short URL; obtaining, by the first server from a first database, based on the received Short URL, a first Long URL and an indication of a Callback API for confirming the first Long URL; and responsive to obtaining the indication of the Callback API: passing the first Long URL to the Callback API; causing the client computer to be redirected to a network location associated with an Updated Long URL returned by the Callback API responsive to passing the first Long URL to the Callback API.

Clause 2. The computer-implemented method of Clause 1, further comprising, by the first server: receiving the Updated Long URL from the Callback API based on passing the first Long URL to the Callback API; and sending, to the client computer, a redirect response containing the Updated Long URL, wherein the redirect response is configured to cause the client computer to automatically navigate to the destination network location using the Updated Long URL without user intervention.

Clause 3. The computer-implemented method of Clause 2, wherein the redirect response comprises an HTTP redirect response.

Clause 4. The computer-implemented method of any one of Clauses 1-3, further comprising: obtaining, by the first server from the first database, in connection with the Long URL, a timestamp indicating when the Short URL was created; and passing, by the first server to the Callback API, the timestamp indicating when the Short URL was created together with the Long URL, wherein the Callback API is caused to obtain the Updated Long URL from a second database based on determining that the first Long URL was updated with the Updated Long URL after the timestamp.

Clause 5. The computer-implemented method of Clause 4, wherein the first Long URL comprises a product code for a first product, the method further comprising: determining, by the Callback API, that the product code was retired or reused for a second product, different than the first product, after the timestamp, wherein the Updated Long URL is configured to redirect the client computer to a destination network location that provides information pertaining to the product code being retired or obsolete.

Clause 6. The computer-implemented method of any one of Clauses 1-5, wherein obtaining the Long URL comprises obtaining a client identifier that identifies a specific client entity that created the Short URL, the method further comprising, by the server, passing the first Long URL to the Callback API together with the client identifier, wherein the client API is caused to obtain the Updated Long URL from a second database based on determining that the first Long URL was updated to the Updated Long URL for the client identifier.

Clause 7. The computer-implemented method of Clause 6, the method further comprising: determining a network address of the Callback API based on the client identifier; and passing the first Long URL to the address of the Callback API.

Clause 8. The computer-implemented method of Clause 7, wherein the client API is hosted by a second server associated with the client identifier and different than the first server, and the network address of the client API comprises an address of the second server.

Clause 9. The computer-implemented method of any one of Clauses 1-8, further comprising, by the first server: receiving and associating, in the first database, before the Short URL is received, context information for the Long URL; obtaining, when the Short URL is received, from the first database, in connection with obtaining the Long URL, the context information; and passing the first Long URL to the Callback API together with the context information.

Clause 10. The computer-implemented method of any one of Clauses 1-9, wherein the Callback API is hosted by a second server, the method further comprising: obtaining, by the Callback API based on the Long URL which was passed to the Callback API, the Updated Long URL from a second database.

Clause 11. The computer-implemented method of any one of Clauses 1-10, wherein the Callback API is hosted by the first server.

Clause 12. The computer-implemented method of any one of Clauses 1-11, wherein the Updated Long URL adds a parameter to the first Long URL or changes a format of one or more parameters in the first Long URL.

Clause 13. The computer-implemented method of any one of Clauses 1-12, wherein passing the Long URL to the Callback API comprises the first server sending to the client computer a redirect response containing a network address of the Callback API and a parameter comprising the Long URL obtained from the database, wherein the redirect response is configured to cause the client computer to automatically navigate to the address of the Callback API so that the Callback API obtains the Updated Long URL based on the parameter and causes the client computer to automatically navigate to the destination network location using the Updated Long URL.

Clause 14. A system, comprising: the first server of claim 1, the first server comprising: one or more processors; and a non-transitory memory storing instructions that, when executed by the one or more processors, causes the one or more processors to facilitate performance of the method of any one of Clauses 1-13.

Clause 15. A non-transitory machine readable medium storing instructions thereon that, when executed by a machine, causes the machine to perform the method of any one of Clauses 1-13.

### Further Considerations:

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention described herein.

The term website, as used herein, may include any aspect of a website, including one or more web pages, one or more servers used to host or store web related content, etc. Accordingly, the term website may be used interchangeably with the terms web page and server. The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

The term automatic, as used herein, may include performance by a computer or machine without user intervention; for example, by instructions responsive to a predicate action by the computer or machine or other initiation mechanism. The word “example” is used herein to mean “serving as an example or illustration.” Any aspect or design described herein as “example” is not necessarily to be construed as preferred or advantageous over other aspects or designs.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “implementation” does not imply that such implementation is essential to the subject technology or that such implementation applies to all configurations of the subject technology. A disclosure relating to an implementation may apply to all implementations, or one or more implementations. An implementation may provide one or more examples. A phrase such as an “implementation” may refer to one or more implementations and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

What is claimed is:

1. A computer-implemented method for generating an Updated Long URL in response to receiving a Short URL, comprising:
receiving, by a first server, a Short URL for redirecting a client computer to a destination network location associated with the Short URL;
obtaining, by the first server from a database, based on the Short URL, a first Long URL, wherein the first Long URL corresponds to a first destination network location; and
responsive to obtaining the first Long URL:
passing the first Long URL to a Callback API;
receiving an Updated Long URL corresponding to a second destination network location, wherein the Updated Long URL is generated by the Callback API responsive to receiving the first Long URL;
causing the client computer to be redirected to the second destination network location associated with the Updated Long URL returned by the Callback API responsive to receiving the Short URL.

2. The computer-implemented method of claim 1, further comprising, by the first server, sending, to the client computer, a redirect response containing the Updated Long URL, wherein the redirect response is configured to cause the client computer to automatically navigate to the destination network location using the Updated Long URL without user intervention.

3. The computer-implemented method of claim 2, wherein the redirect response comprises an HTTP redirect response.

4. The computer-implemented method of claim 1, further comprising:
obtaining, by the first server from the database, in connection with the first Long URL, a timestamp indicating when the Short URL was created; and
passing, by the first server to the Callback API, the timestamp indicating when the Short URL was created together with the first Long URL, wherein the Callback API generates the Updated Long URL based on determining that an update event occurred after the timestamp.

5. The computer-implemented method of claim 4, wherein the first Long URL comprises a product code for a first product, the method further comprising:
determining, by the Callback API, that the product code was retired or reused for a second product, different than the first product, after the timestamp,
wherein the second destination network location provides information pertaining to the product code being retired or obsolete.

6. The computer-implemented method of claim 1,
wherein obtaining the first Long URL comprises obtaining a client identifier that identifies a specific client entity that created the Short URL,
the method further comprising, by the first server, passing the first Long URL to the Callback API together with the client identifier,
wherein the Callback API is caused to generate the Updated Long URL based on determining that an update event occurred for the client identifier.

7. The computer-implemented method of claim 6, the method further comprising:
determining a network address of the Callback API based on the client identifier; and
passing the first Long URL to the network address of the Callback API.

8. The computer-implemented method of claim 7, wherein the Callback API is hosted by a second server associated with the client identifier and different than the first server, and the network address of the Callback API comprises an address of the second server.

9. The computer-implemented method of claim 1, further comprising, by the first server:
receiving and associating, in the database, before the Short URL is received, context information for the first Long URL;
obtaining, when the Short URL is received, from the database, in connection with obtaining the first Long URL, the context information; and
passing the first Long URL to the Callback API together with the context information.

10. The computer-implemented method of claim 1, wherein the Callback API is hosted by a second server, the method further comprising:
obtaining, by the Callback API based on the first Long URL which was passed to the Callback API, the Updated Long URL from a second database.

11. The computer-implemented method of claim 1, wherein the Callback API is hosted by the first server.

12. The computer-implemented method of claim 1, wherein the Updated Long URL adds a parameter to the first Long URL or changes a format of one or more parameters in the first Long URL.

13. The computer-implemented method of claim 1,
wherein passing the first Long URL to the Callback API comprises the first server sending to the client computer a redirect response containing a network address of the Callback API and a parameter comprising the Long URL obtained from the database,
wherein the redirect response is configured to cause the client computer to automatically navigate to the network address of the Callback API so that the Callback API generates the Updated Long URL based on the parameter and causes the client computer to automatically navigate to the destination network location using the Updated Long URL.

14. A URL redirection system, comprising:
one or more processors; and
a non-transitory memory storing instructions that, when executed by the one or more processors, causes the one or more processors to perform operations comprising:
receiving, by a first server, a Short URL for redirecting a client computer to a destination network location associated with the Short URL;
obtaining, by the first server from a database, based on the Short URL, a first Long URL, wherein the first Long URL corresponds to a first destination network location; and
responsive to obtaining the first Long URL:
passing the first Long URL to a Callback API;
receiving an Updated Long URL corresponding to a second destination network location, wherein the Updated Long URL is generated by the Callback API responsive to receiving the first Long URL;
causing the client computer to be redirected to the second destination network location associated with the Updated Long URL returned by the Callback API responsive to receiving the Short URL.

15. A non-transitory machine readable medium storing instructions thereon that, when executed by a machine, causes the machine to perform operations comprising:
receiving, by a first server, a Short URL for redirecting a client computer to a destination network location associated with the Short URL;
obtaining, by the first server from a database, based on the Short URL, a first Long URL, wherein the first Long URL corresponds to a first destination network location; and
responsive to obtaining the first Long URL:
passing the first Long URL to a Callback API;
receiving an Updated Long URL corresponding to a second destination network location, wherein the Updated Long URL is generated by the Callback API responsive to receiving the first Long URL;
causing the client computer to be redirected to the second destination network location associated with the Updated Long URL returned by the Callback API responsive to receiving the Short URL.
